(19) United States
(12) Patent Application Publication
(10) Pub. No.: US 2005/0248542 A1
(43) Pub. Date: Nov. 10, 2005

(54) Input device and method for controlling input device

(75) Inventor: Keiji Sawanobori, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/117,419

(22) Filed: Apr. 29, 2005

(30) Foreign Application Priority Data
May 7, 2004 (JP) P2004-138715

(51) Int. Cl. G09G 5/00

(52) U.S. Cl. 345/173

(57) ABSTRACT

An input device comprises a display and a touch panel, which are combined with each other. A menu, shown on a surface of the display, contains signs for prompting an input operation, which is carried out through the touch panel. A moving direction, from a first touch position to a second touch position, is obtained. The first touch position is defined by touching the touch panel with a finger. The second touch position is defined by moving the finger while keeping the finger in contact with the touch panel. A sign is selected, which is positioned on a straight line extending in the moving direction, from the signs contained in the menu.

### BACKGROUND OF THE INVENTION

1. Field of the Invention

The present invention relates to an input device, which has a touch panel on which a user makes contact with a finger to input information.

2. Description of the Related Art

Conventionally, there is known an information input device, which is constructed by combining a display for indicating an image and so on, and a touch panel laid on a surface of the display. A sign, including an icon, a mark, and a character, for prompting an input operation is indicated on the display. Thus, when a user touches the sign, or when the user touches an area of the touch panel, corresponding to the sign, it is deemed that the sign is selected, so that an input operation corresponding to the sign is carried out.

Such an input device is easily operated in comparison with a keyboard and so on, since the user may only touch the display with a finger. However, the input device has problems as follows. Namely, if the display has a large size, the user has to move a finger over a wide range so as to select the sign, which causes problems regarding the operability of the display. Further, in an apparatus, such as a cellular phone, which is usually operated by one hand, it is difficult to touch a sign on the display while holding the cellular phone in one hand.

### SUMMARY OF THE INVENTION

Therefore, an object of the present invention is to improve the operability of the input operation using the touch panel.

According to the present invention, there is provided an input device comprising a display, a menu indicating processor, a touch panel, a moving direction obtaining processor, and a control processor.

The menu indicating processor indicates a menu containing signs for prompting an input operation. The touch panel is used in combination with the display. The moving direction obtaining processor obtains a moving direction from a first touch position to a second touch position. The first touch position is defined by touching the touch panel with a finger. The second touch position is defined by moving the finger while keeping the finger in contact with the touch panel. The control processor selects the sign, positioned on a straight line extending in the moving direction, from the signs contained in the menu.

Further, according to the present invention, there is provided a method for controlling an input device comprising a display, a menu indicating processor indicating a menu containing signs for prompting an input operation, and a touch panel used in combination with the display. The method comprising a selecting step for selecting a sign, which is contained in a menu to prompt an input operation, based on a movement of a touch position on the touch panel; and a processing step for performing a process indicating that the sign is selected.

Thus, in the present invention, a sign, indicated on the display, is selected not based on a touch position at which a finger touches the touch panel, but based on a moving direction of the touch. Namely, when any sign is to be selected on a surface on the display, it is not necessary for the user to vary the touch position largely in accordance with the indicating position of the sign. The selecting operation can be performed only by a movement of a finger on the touch panel toward the sign.

According to the present invention, a moving amount of a finger or hand of the user can be reduced, when operating the touch panel, and therefore, the operability is improved. Especially, when the display is large, the amount of movement, required for the operation, is drastically decreased. Further, when the display is applied to a cellular phone, since the operation for choosing the sign can be performed with a finger of the hand in which the cellular phone is held, the operability is effectively improved.

### BRIEF DESCRIPTION OF THE DRAWINGS

The objects and advantages of the present invention will be better understood from the following description, with reference to the accompanying drawings in which:

FIG. 1 is a block diagram of a cellular phone with a camera, to which a first embodiment of the present invention is applied;

FIG. 2 is a flowchart showing steps from an initialization to an operation in which a touch panel is first touched, in a setting of a photographing condition;

FIG. 3 is a flowchart showing the steps taken until a sign is selected, in the setting of a photographing condition;

FIG. 4 is a flowchart showing until a process corresponding to the selected sign is decided to be performed, in the setting of the photographing conditions;

FIG. 5 is a view showing an initial frame indicated on an LCD:

FIG. 6 is a view showing an indication of the LCD when the user first touches a touch panel, after the initial frame is indicated;

FIG. 7 is a view showing an indication of the LCD when the user moves the touch position to select a sign;

FIG. 8 is a view showing an indication of the LCD when the user returns the touch position to the initial position to decide to perform a process corresponding to the selected sign;

FIG. 9 is a view showing an indication of the LCD when the process corresponding to the selected sign is performed;

FIG. 10 is an initial part of a flowchart for setting a photographing condition, in a cellular phone with a camera to which a second embodiment of the present invention is applied; and

FIG. 11 is a latter part of the flowchart shown in FIG. 10.

### DESCRIPTION OF THE PREFERRED EMBODIMENTS

The present invention will be described below with reference to embodiments shown in the drawings.

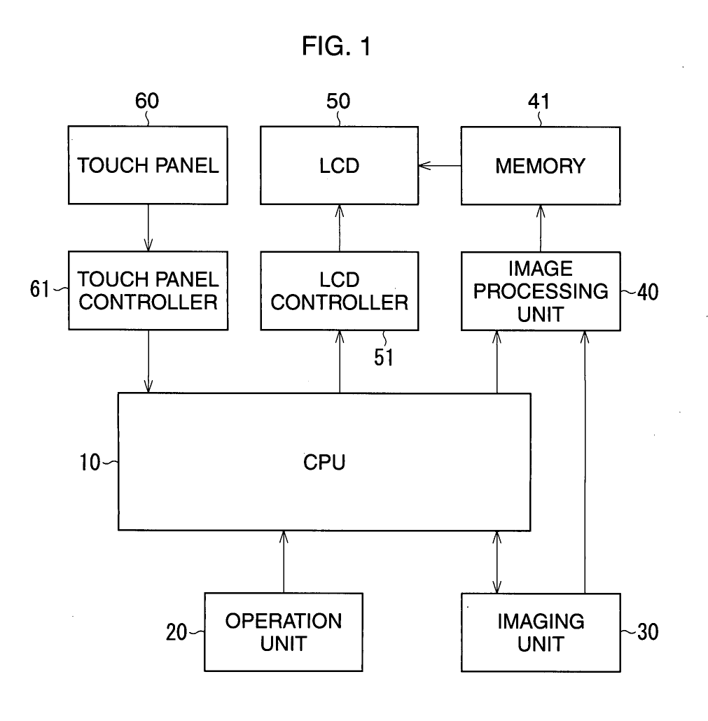

FIG. 1 is a block diagram of a cellular phone with a camera, to which a first embodiment of the present invention is applied. In FIG. 1, a communication unit of the cellular phone is omitted. The cellular phone is controlled through a CPU 10 as a whole. An operation unit 20 having various operation buttons is connected to the CPU 10. Thus, when an operation button is depressed by a user, an input signal is input from the operation unit 20 to the CPU 10, and the corresponding process is performed.

An imaging unit 30 has a photographing optical system, a CCD, and so on. In the imaging unit 30, an optical image obtained through the photographing optical system is photoelectrical-converted by the CCD, so that an analogue image signal is generated. The analogue image signal is input to an image processing unit 40, in which the analogue image signal is A/D-converted, and the digital image signal is subjected to a predetermined image processing. The image-processed digital image signal or image data is stored in a memory 41.

In the memory 41, other than the image-processed image data, image data corresponding to various kinds of signal for prompting input operations are stored.

An LCD 50 is connected to the CPU 10 through an LCD controller 51. When a control signal is output from the CPU 10, an image corresponding to the image data stored in the memory 41 is indicated on the LCD 50 in accordance with a control of the LCD controller 51.

A touch panel 60 is laid on the LCD 50, and is connected to the CPU 10 through a touch panel controller 61. That is, the touch panel 60 is used in combination with the LCD 50. Thus, when the user of the cellular phone touches the touch panel 60, a response signal corresponding to the touch position is input to the CPU 10 from the touch panel controller 61. In the CPU 10, based on the response signal, coordinates of the touch position, in the coordinate system defined on the LCD 50, are calculated or obtained, and the processes described later are performed in accordance with the coordinates.

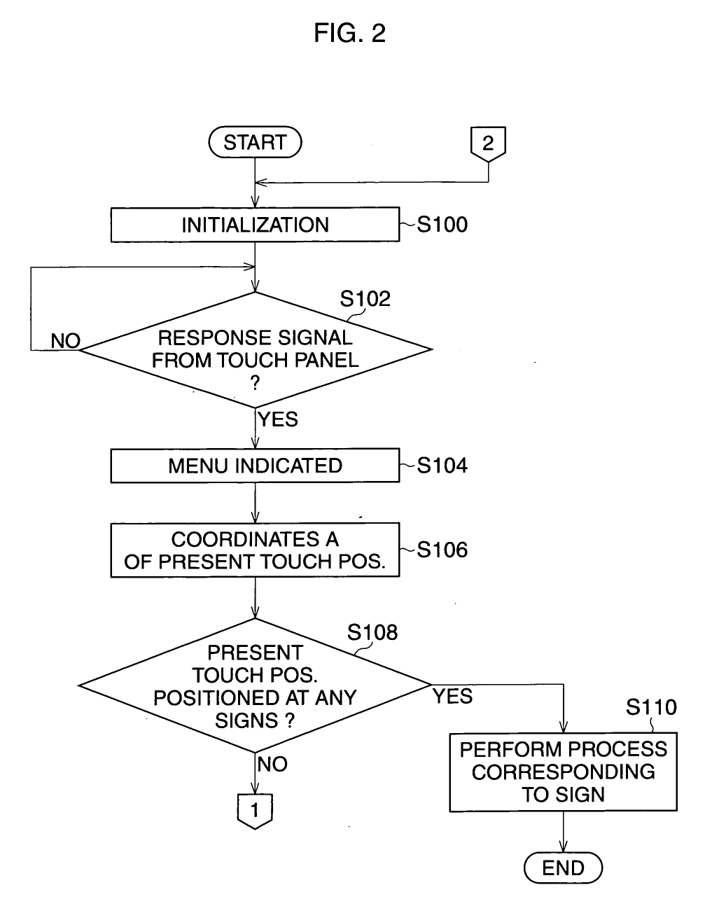

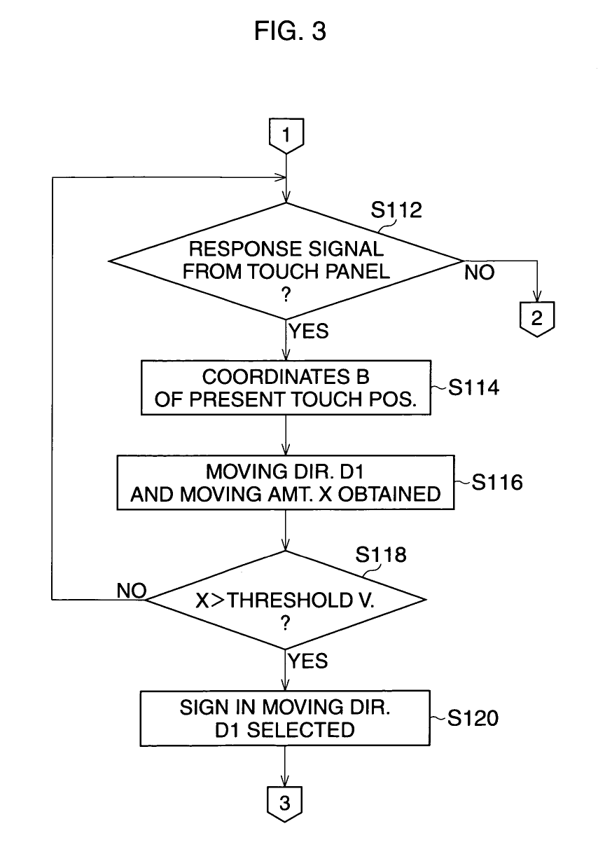

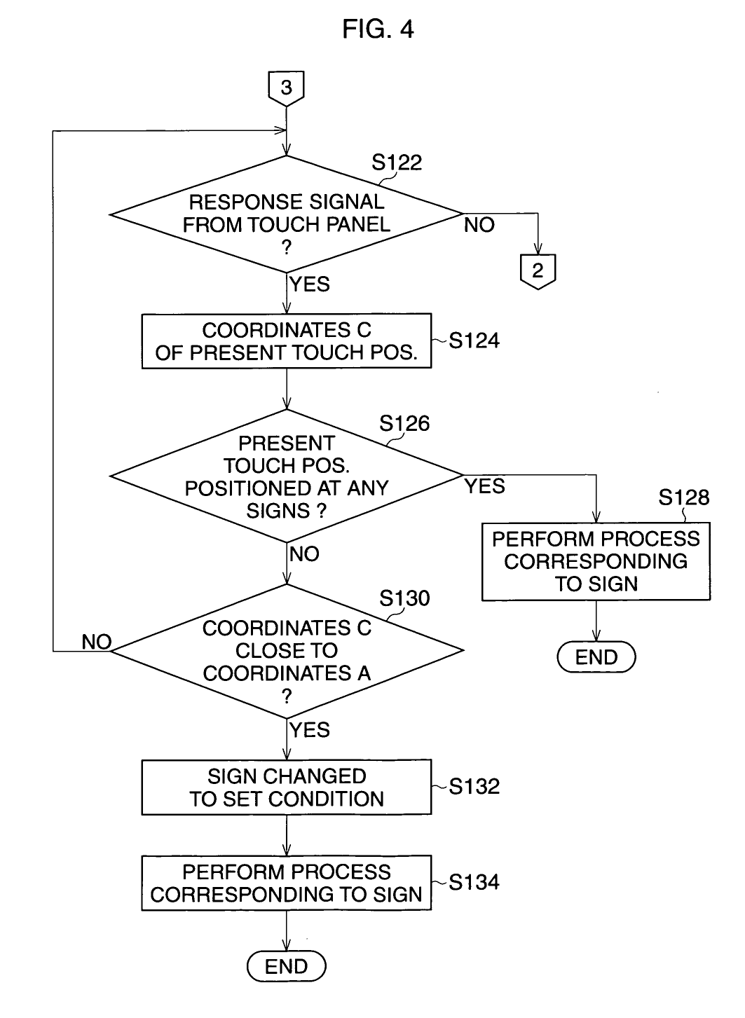

With reference to FIGS. 2 through 4, steps regarding an input operation to the touch panel 60 in the first embodiment are described below. FIGS. 2 through 4 show a flowchart containing steps in which the photographing conditions are set through the touch panel 60 when photographing a subject.

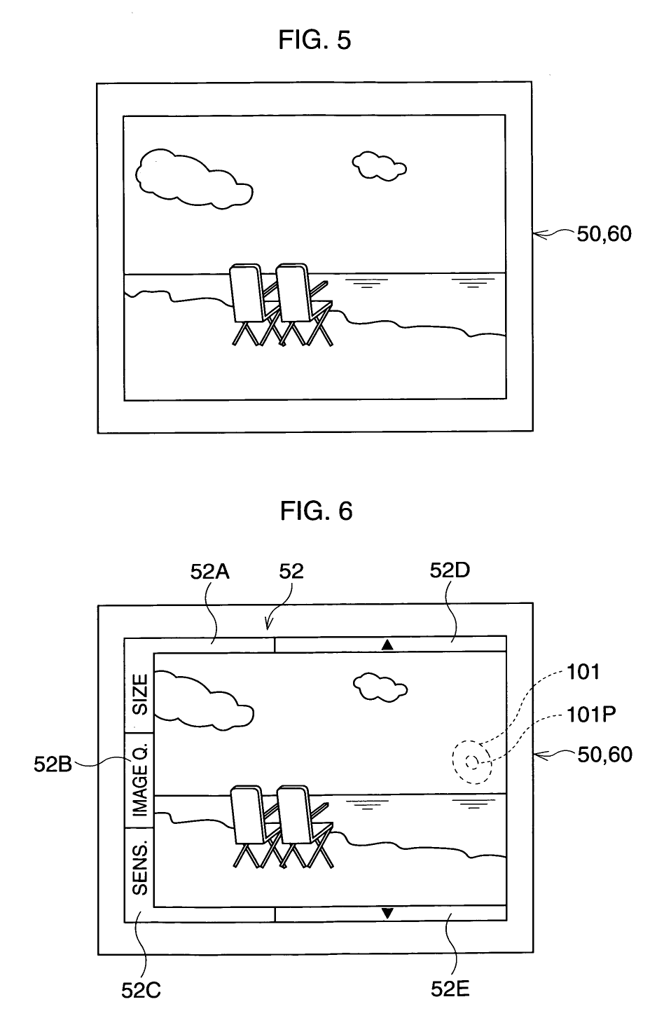

In Step S100, an initialization for indicating an image is carried out, so that a subject to be photographed is indicated on the LCD 50 as shown in FIG. 5. In Step S102, itis judged whether a response signal, indicating that the touch panel 60 is touched with a finger, for example, is input from the touch panel controller 61. When the input of the response signal is confirmed, the routine goes to Step S104, in which a menu 52 for setting the photographing condition is indicated as shown in FIG. 6.

In the first embodiment, the menu 52 has signs 52A, 52B, 52C, 52D, and 52E, which are indicated on a periphery of an indication area provided on the LCD 50, to form a channel shape. It is supposed that the user holds the cellular phone with the right hand, and thus, no sign is indicated on the right side of the LCD 50. Note that the area, in which no sign is indicated, is not restricted to the right side of the LCD 50, and can be changed to the left side of the LCD 50, depending upon the preference of the user. Thus, the menu 52 is indicated on a part of the periphery, around which a hand of the user does not access.

The sign 52A is provided for selecting a recording size of an image, the sign 52B is provided for selecting the image quality, and the sign 52C is provided for selecting the sensitivity. The signs 52D and 52E are provided for changing or scrolling the menu to another choice. Note that, in FIG. 6, an area 101 enclosed by a broken line indicates a first touch position, which was first touched by the user, and the reference 101P indicates the center of the area of the first touch position 101. Namely, the first touch position 101 is defined by touching the touch panel 60 with a finger after the touch panel 60 is not touched with the finger.

In Step S106, the present coordinates A of the center 101P of the touch position 101 are obtained by calculation. Then, in Step S108, it is checked if the center 101P is positioned in the areas of the signs 52A through 52E, based on the coordinates of the center 10P. When it is confirmed that the center 101P is in the areas of the signs 52A through 52E, Step S110 is executed to perform a process corresponding to the sign. Conversely, when it is confirmed that the center 101P is not positioned at any areas of the signs 52A through 52E, Step S112 is executed.

In Step S112, it is checked whether the response signal is continuously being input from the touch panel controller 61. A case in which the response signal is not input, happens when the user releases the finger from the touch panel 60. In this case, the routine goes back to Step S100. Namely, the menu 52, indicated at Step S104, is deleted, and the indication of LCD 50 is returned to the state shown in FIG. 5.

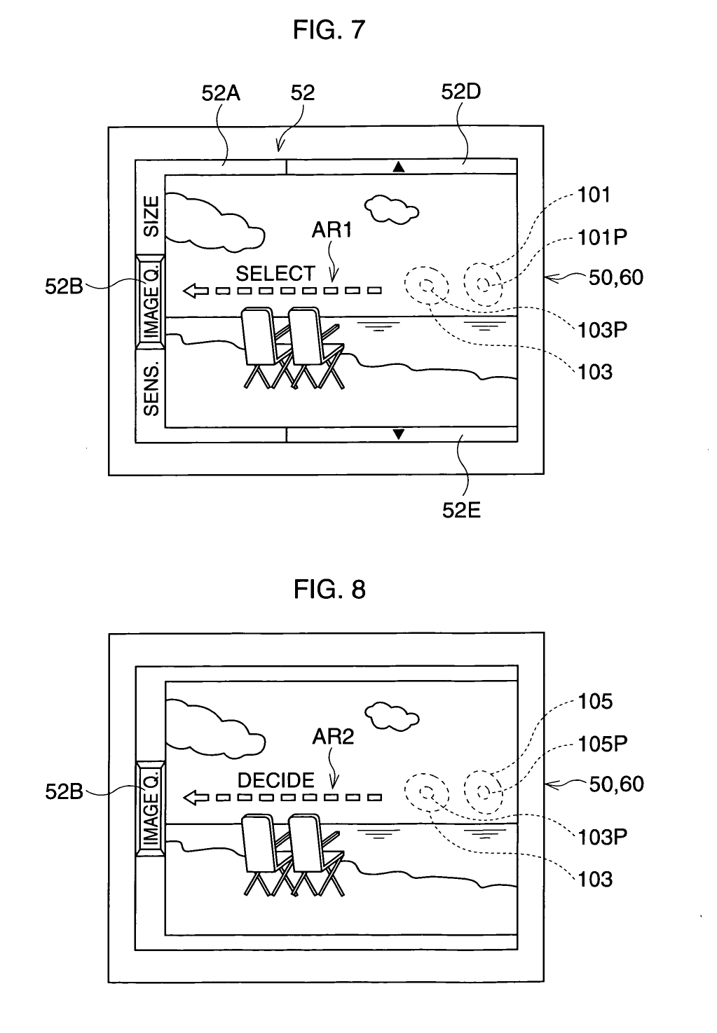

When the user does not release the finger from the touch panel 60, so that it is confirmed that the response signal is continuously input from the touch panel controller 61, Step S114 is executed. In Step S114, based on the response signal from the touch panel controller 61, the coordinates of the center of the touch position, at which the user is now touching, are obtained by calculation. As shown in FIG. 7, when the user moves the finger, while keeping the finger in contact with the touch panel 60, from the first touch position 101 to a second touch position 103 on the touch panel 60, the coordinates B of the center position 103P of the second touch position 103 are obtained by calculation.

The routine then goes to Step S116, in which the moving direction D1 and the moving amount X, from the coordinates A to the coordinates B, are obtained by calculation. In Step S118, it is checked whether the moving amount X or the distance between the first touch position 101 and the second touch position 103, exceeds a predetermined threshold value. When it is confirmed that the moving amount X exceeds the threshold value, Step S120 is executed, in which a process is performed so that the sign, positioned on a straight line extending in the moving direction D1, is selected from the signs contained in the menu 52.

As shown in FIG. 7, the sign 52B exists on the straight line extending in the moving direction D1. Accordingly, the sign 52B is changed to appear as if the button of the sign 52B is depressed, and an arrow or mark AR1, which is shown as a broken line to indicate the moving direction, and the characters “SELECT”, are indicated on the LCD 50. Thus, the user is informed that the sign 52B has been selected.

When it is confirmed in Step S118 that the moving amount X does not exceeds the threshold value, the routine goes back to Step S112, the calculations for the moving direction D1 and the moving amount X are repeated. Namely, when the length, by which the finger slides on the touch panel 60, does not exceed the predetermined amount, no sign is selected.

After Step S120 is executed, the process goes to Step S122, in which it is checked whether the response signal is continuously input from the touch panel controller 61, in a similar way as Step S112. When the user releases the finger from the touch panel 60, so that the response signal is not input, the routine goes back to Step S100. As a result, the menu 52 and the arrow AR1 are deleted, the indication on the LCD 50 is resumed to a state shown in FIG. 5. In other words, the moving direction obtaining process is canceled, when the response signal is not received.

When the user does not release the finger from the touch panel 60, so that it is confirmed that the response signal is continuously input from the touch panel controller 61, Step S124 is executed. In Step S124, based on the response signal from the touch panel controller 61, the coordinates of the center of the touch position, at which the user is now touching, are obtained by calculation. As shown in FIG. 8, when the user moves the finger, while keeping the finger in contact with the touch panel 60, from the second touch position 103 to a third touch position 105 on the touch panel 60, the coordinates C of the center position 105P of the third touch position 105 are obtained by calculation.

Then, in Step S126, it is checked in which areas of the signs 52A through 52E the center 105P is positioned, based on the coordinates C. When it is confirmed that the center 105P is positioned in the areas of the signs 52A through 52E, Step S128 is executed to perform a process corresponding to the sign. Conversely, when it is confirmed that the center 105P is not positioned in any of the areas of the signs 52A through 52E, Step S130 is executed.

In Step S130, the coordinates A are compared with the coordinates C, so that it is checked whether the center 105P is positioned close to the center 101P. When it is confirmed that the center 105P is positioned close to the center 101P (see FIGS. 6 and 7), Step S132 is executed, in which the sign 52B, set to the selected condition, is changed to the decision condition. Thus, as shown in FIG. 8, the signs other than the sign 52B are deleted, and the characters “DECIDE” are indicated above the arrow AR2. Namely, a process corresponding to the sign 52B is determined.

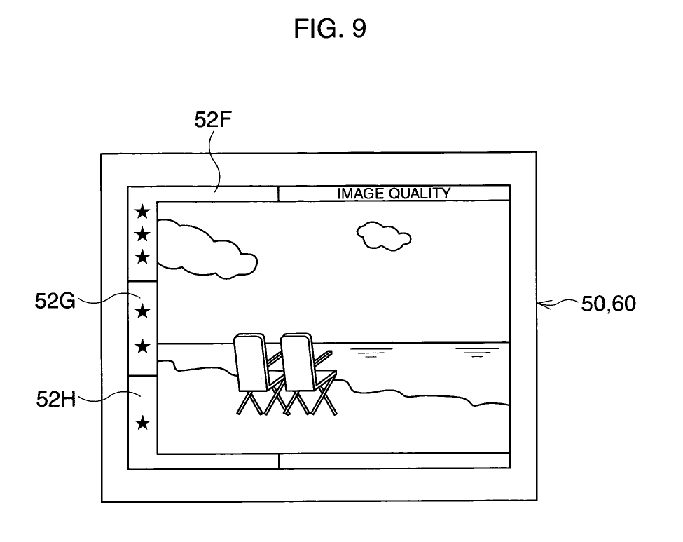

Then, in Step S134, a process for indicating a menu for deciding an image quality, is executed according to the decision regarding sign 52B. As a result, the indication on the LCD 50 becomes that shown in FIG. 9, in which signs 52F, 52G, and 52H are provided for selecting a level of image quality. The image quality becomes higher as the number of stars increases.

Note that, when it is confirmed in Step S130 that the center 105P is not positioned close to the center 101P, the routine goes back to Step S122, and the operations described above are repeated. Namely, if the position, to which the finger slides after the sign is selected, is greatly separated from the center 101P, the sign is not changed to the decision condition.

As described above, according to the first embodiment, the sign is selected and a process, corresponding to the sign, is decided to be performed, by moving the touch position back and fro along a straight line while keeping the finger in contact with the touch panel 60. Therefore, the touch panel 60 can be operated with a finger of a hand in which the cellular phone is held, so that the operability of the touch panel is improved.

Further, in the first embodiment, when the touch position is moved and returned to the initial position, the decision to select the sign to perform the corresponding process is finalized. Namely, before carrying out a process corresponding to the sign, the selection of the sign can be changed. Therefore, even if the user is not familiar with the operation, it is easy to select the sign and decide to perform the corresponding process.

Furthermore, according to the first embodiment, the signs can be disposed along the periphery of the LCD 50. In other words, it is not necessary that the signs are indicated at the central portion of the LCD 50. Therefore, as shown in FIGS. 5 through 9, the image indication of the subject to be photographed is not interfered with by the signs, so that the user can always observe or confirm the subject to be photographed.

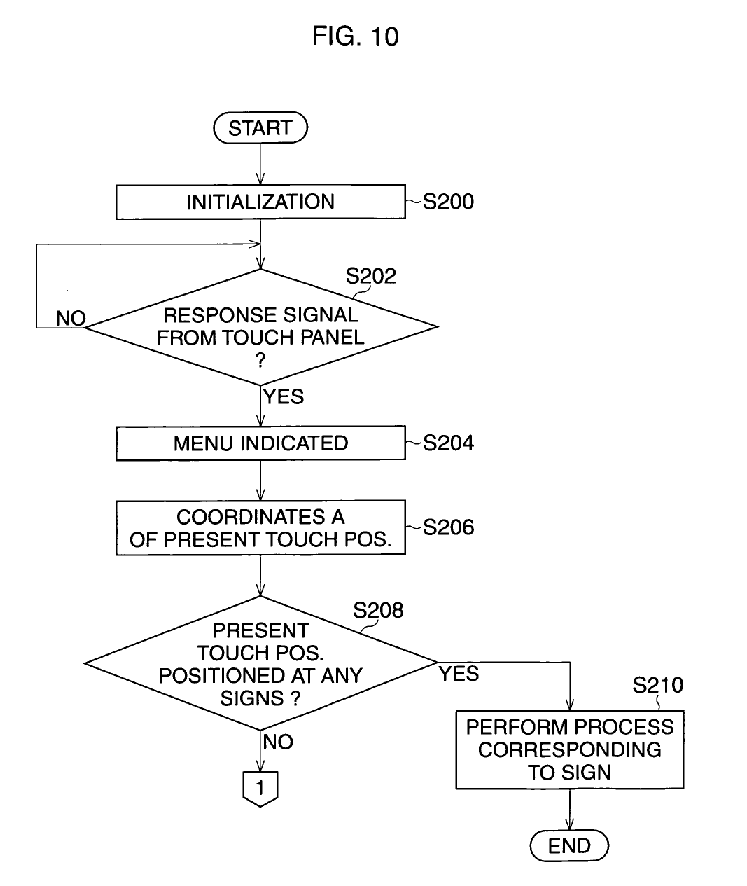

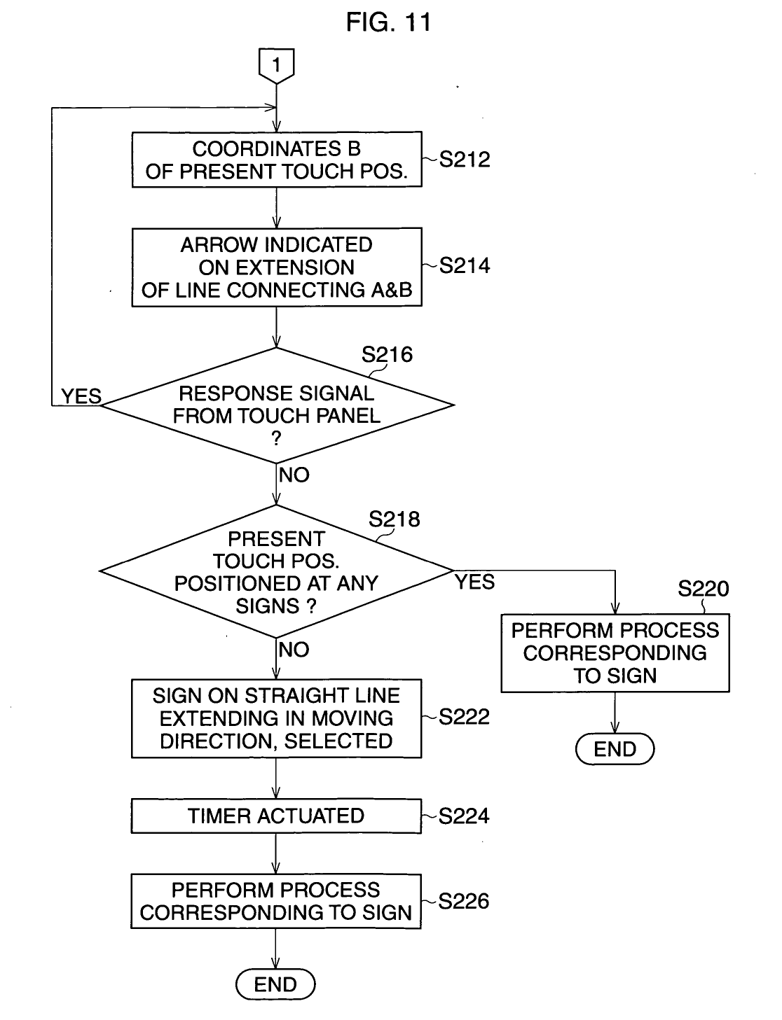

With reference to FIGS. 10 and 11, steps regarding an input operation for the touch panel 60 in a second embodiment are described below. A cellular phone of the second embodiment has the same control system as that of the first embodiment shown in FIG. 1. FIGS. 10 and 11 show a flowchart containing steps in which the photographing conditions are set through the touch panel 60 when photographing a subject, similar to FIGS. 2 through 4.

The contents of Steps S200 through S210 shown in FIG. 10 are the same as those of Steps S100 through S110 shown in FIG. 2. Namely, the indication of the initial frame shown in FIG. 5 (S200), the confirmation of the first touch on the touch panel 60 (S202), the indication of the menu shown in FIG. 6 (S204), the obtaining of coordinates A of the first touch position (S206), and the operations when a sign is selected (S208, S210) are carried out.

In Step S212 shown in FIG. 11, the coordinates B of the present or second touch position are obtained by calculation, based on a response signal from the touch panel controller 61. In Step S214, an arrow is indicated on an extension of a straight line connecting the point of coordinates A (obtained in Step S206) and the point of coordinates B (see reference AR1 of FIG. 7). In Step S216, it is checked whether a response signal is being input from the touch panel controller 61. When the response signal is being input, the routine goes back to Step S212. Namely, while the user moves the finger, while keeping the finger in contact with the touch panel 60, the coordinates B of the present or second touch position are obtained by calculation.

When it is confirmed in Step S216 that a response signal is not input from the touch panel controller 61, Step S218 is executed. In Step S218, it is checked whether the coordinates B correspond to any area of the signs of the menu 52, so that it is checked whether the user has released the finger from the touch panel 60 at a sign or not. When it is confirmed that the user has released the finger at a sign, Step S220 is executed to perform a process corresponding to the sign.

Conversely, when it is confirmed that the user has released the finger at a position other than a sign, Step S222 is executed. In Step S222, a moving direction D2, from the coordinates A to the coordinates B, is obtained by calculation, so that a sign, existing on a straight line extending in the moving direction D2, is selected, and a process corresponding to the sign is decided to be performed. As a result, signs other than the selected sign are deleted from the LCD 50.

Then, in Step S224, a timer, for invalidating an input operation to the touch panel 60 for a predetermined time period, is actuated. Thus, for the predetermined time period after a sign is selected and the corresponding process is decided to be performed, even if the user touches the touch panel 60, the input is disregarded. Therefore, an erroneous operation is prevented, in which, after selecting a sign, a process corresponding the sign is decided to be performed against the user's will because the user accidentally touches the touch panel 60. When the predetermined time period has passed after activation of the timer, or after the second touch position was defined, Step S226 is executed, in which a process corresponding to the sign is carried out.

As described above, in the second embodiment, a sign is selected and a process corresponding to the sign is decided to be performed, only by moving or sliding a finger from the first touch position for a predetermined distance while keeping the finger in contact with the touch panel 60. Thus, the operation is simple.

Note that the first embodiment and the second embodiment may be applied to a single cellular phone, so that the user can select one of the operations of the first and second embodiments. Further, the present invention can be applied to a device other than a cellular phone.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2004-138715 (filed on May 7, 2004) which is expressly incorporated herein, by reference, in its entirety.

1. An input device comprising:
a display;
a menu indicating processor that indicates a menu containing signs for prompting an input operation;
a touch panel that is used in combination with said display;
a moving direction obtaining processor that obtains a moving direction from a first touch position to a second touch position, said first touch position being defined by touching said touch panel with a finger, said second touch position being defined by moving said finger while keeping said finger in contact with said touch panel; and
a control processor that selects the sign, positioned on a straight line extending in said moving direction, from said signs contained in said menu.

2. A device according to claim 1, further comprising a touch-position obtaining processor that obtains said first and second touch positions.

3. A device according to claim 1, wherein said control processor selects the sign positioned on said straight line, when a distance between said first touch position and said second touch position exceeds a predetermined threshold value.

4. A device according to claim 1, wherein said control processor determines to perform a process corresponding to the sign, when said finger is moved, while keeping said finger in contact with said touch panel, from said second touch position to a third touch position, which is close to said first touch position.

5. A device according to claim 1, further comprising a first informing processor indicating that the sign, positioned on said straight line, is selected.

6. A device according to claim 5, wherein said first informing processor indicates a mark, meaning said moving direction, on said display.

7. A device according to claim 5, further comprising a second informing processor for deleting the contents indicated by said first informing processor, and indicating that a process corresponding to the sign is to be performed.

8. A device according to claim 1, wherein said control processor cancels the process of said moving direction obtaining processor, when said control processor does not receive a response from said touch panel.

9. A device according to claim 1, wherein said control processor determines to perform a process corresponding to the sign, when the finger is released from said touch panel at said second touch position.

10. A device according to claim 1, wherein said control processor determines to perform a process corresponding to the sign, when a predetermined period of time has passed after said second touch position was defined.

11. A device according to claim 1, wherein said menu is indicated on a periphery of an indication area provided on said display.

12. A device according to claim 11, wherein said menu is indicated on a part of said periphery, around which a hand of a user does not access.

13. A method for controlling an input device comprising a display, a menu indicating processor for indicating a menu containing signs for prompting an input operation, and a touch panel used in combination with said display, said method comprising:
a selecting step for selecting a sign, which is contained in a menu to prompt an input operation, based on a movement of a touch position on said touch panel; and
a processing step for performing a process indicating that said sign is selected.

14. A method according to claim 13, wherein said selecting step comprises:
a first touch position defining step for defining a first touch position when receiving a response from said touch panel when said touch panel has not yet been touched with a finger;
a second touch position defining step for defining a second touch position when said finger moves from said first touch position for a predetermined distance while keeping said finger in contact with said touch panel;
an obtaining step for obtaining a moving direction from said first touch position to said second touch position, so that said selecting step selects said sign, positioned on a straight line extending in said moving direction;
a third touch position defining step for defining a third touch position when said finger moves from said second touch position while keeping said finger in contact with said touch panel; and
a determining step for determining to perform a process corresponding to said sign, when said third touch position is close to said first touch position.

15. A method according to claim 13, wherein said selecting step comprises:
a first touch position defining step for defining a first touch position when receiving a response from said touch panel when said touch panel has not yet been touched with a finger;
a second touch position defining step for defining a second touch position when said finger moves from said first touch position for a predetermined distance while keeping said finger in contact with said touch panel;
an obtaining step for obtaining a moving direction from said first touch position to said second touch position, so that said selecting step selects said sign, positioned on a straight line extending in said moving direction; and
a determining step for determining to perform a process corresponding to said sign, when said second touch position is defined and a predetermined period of time has passed after said second touch position was defined.

16. A method according to claim 15, wherein said moving direction is indicated on said display.
